(19) United States
(12) Patent Application Publication
(10) Pub. No.: US 2003/0033266 A1
(43) Pub. Date: Feb. 13, 2003

(54) Apparatus and method for problem solving using intelligent agents

(76) Inventors: Wade F. Schott, Santa Clara, CA (US); Thanh A. Diep, Houston, TX (US)

Correspondence Address: JENNER & BLOCK, LLC, ONE IBM PLAZA, CHICAGO, IL, 60611, US

(21) Appl. No.: 09/927,826

(22) Filed: Aug. 10, 2001

(51) Int. Cl. G06N 5/00; G06F 17/00; G06N 5/02; G06F 15/00; G06F 15/18

(52) U.S. Cl. 706/45; 706/46; 706/50

(57) ABSTRACT

An apparatus and method for iterative problem solving that uses intelligent agents such as a brain agent, a profile agent, a personality agent, a knowledge agent and an error handling agent to interpret questions posed by a user and to provide responses back to the user. The apparatus and method may further use a mood agent, a visual agent, sound agent, a tactile agent, and a smell/taste agent and various connectors to external data sources to interpret questions and provide responses back to the user. The apparatus and method may further parse questions in a conceptual manner. The apparatus and method may further optimize its system performance by evolving with and reacting to user interactions.

### BACKGROUND OF THE INVENTION

1. Field of the Invention

The present invention relates generally to artificial or machine intelligence, and more specifically to a system and method for problem solving using intelligent agents.

2. Description of the Related Art

With the rapid increase in usage of the Internet in recent times, people are turning to computers for answers to everyday questions in the form of natural language with ever increasing regularity. Artificial or machine intelligence has been under development for many years, but is now gaining attention from the general public as Web sites such as Askjeeves.com allow users to input questions to obtain desired information. Another such example is SynTactic Analysis using Reversible Transformations (“START”), that was developed at MIT's Artificial Intelligence Laboratory. Connected to the World Wide Web since December, 1993, START is a software system designed to answer questions that are posed to it in natural language. START uses a special form of annotations to perform text retrieval. An example of such annotations to perform text retrieval is provided in U.S. Pat. No. 5,309,359 to Katz et al. Another similar system is Cycorp's “Cyc” system. Cyc provides the capability for answering natural language questions using its proprietary knowledge base. While Cyc uses an agent-based architecture, the intelligent agents are of the same type, working in parallel to cover different “knowledge” space.

However, no artificial or computer intelligence systems presently available utilize individual components, each with a dedicated function, that collaborate with one another to help interpret a user's input and construct a response. Conventional systems presently available likewise do not parse a user's input in a conceptual manner. In addition, conventional systems presently available do not include characteristics specific to the individual asking the question when interpreting the question and constructing a response to the question.

Therefore, it would be desirable to provide an artificial intelligence system that utilizes components that are dedicated to specific tasks and collaborate with one another to help interpret a user's input and to generate responses to the user's input. It likewise would be desirable to provide an artificial intelligence system that parses input in a conceptual, rather than grammatical, manner. Additionally, it would be desirable to provide an artificial intelligence system that utilizes characteristics specific to the individual user when generating responses to the user's input.

### SUMMARY OF THE INVENTION

The present invention is an apparatus and method for iterative problem solving using intelligent agents. The present invention is capable of taking as input a question that is phrased in natural language syntax, a question that is phrased in natural language syntax coupled with additional information including, without limitation, video or audio data, or any other input to which a response may be provided (“human question”) and providing as output a response to the question that likewise is in natural language syntax, in natural language syntax coupled with additional data including, without limitation, video or audio data, or any other form of output that can be understood by a human (“human answer”). For example, a user interacting with the present invention could hold up a picture to a camera and ask the question, “Who is in this picture?” As another example, a user could play an audio clip into a microphone after asking the question, “Who is the composer of the following symphony?”

To provide a human answer in response to a human question, the present invention employs various components commonly referred to in the art as software intelligent agents (hereinafter “intelligent agents”). These intelligent agents decompose the human question into one or more basic elements that can be interpreted by the intelligent agents to construct a response. The intelligent agents are capable of interacting with the user to clarify or refine the human question presented and to clarify any errors or ambiguities that cannot be resolved internally by the intelligent agents. The process of taking a human question and responding with a human answer according to the present invention typically starts with the user asking a question. The question typically is then parsed and translated to a structured form, referred to as “S”. Next, the present invention typically tries to match S with another structured-form entry within its questionnaire database, called the matched entry, “M.” The present invention then typically determines the set of refined questions that were previously linked to M; which is commonly referred to in the art as a decomposition step. This set of questions typically would then be internally addressed or outsourced to an external system to prepare the answers, which are transmitted back to the user.

The present invention overcomes the limitations of conventional software intelligent agents because it may use one or more intelligent agents that are dedicated to specific functions and then coordinating the individual intelligent agents to interact with one another to provide responses that typically are more relevant than responses obtained with conventional methods. The present invention likewise overcomes the limitations of conventional software intelligent agents because it may parse input in a conceptual manner. The present invention further overcomes the limitations of conventional software intelligent agents because it may utilize the personality and other characteristics specific to the individual user interacting with the invention to better interpret and respond to the user's input.

In one aspect of the present invention, the intelligent agents overcome the foregoing limitations by interacting with one another to provide the best interpretation of the posed question according to the user's specific characteristics and other contextual information as a result of the interactions among the intelligent agents. In addition, the intelligent agents may provide a means for the user to pose a complex question with indirect references. As an example of such a complex question with indirect references, a user could show a picture to a camera and ask, “Who is in this picture?” The present invention likewise may access external data sources for additional information or assistance with interpreting the human question posed by the user. The present invention also may adapt and improve itself through interacting with the user as it collects information from each session.

The present invention comprises one or more intelligent agents including a language agent, a knowledge agent, and a brain agent that functions to coordinate the activities of the foregoing agents to interpret the input provided by the user and to provide a response to the user's input. The present invention may further comprise additional intelligent agents including, without limitation, a personality agent, a profile agent, an error handling agent, a mood agent, a visual agent, a sound agent, a tactile agent, and a smell/taste agent as well as connectors to external data sources for use in providing a response to a user's input.

Operating under the coordination of the brain agent, each intelligent agent specializes in an area of expertise. For example, the knowledge agent provides a knowledge store of factual information (e.g., that Lhasa is the capital city of Tibet and that dodos are extinct birds from Mauritius, Africa). As another example, the language agent covers all aspects of languages, including, without limitation, vocabulary, syntax, diction, translation, and idioms. A detailed discussion of the individual intelligent agents is provided below. In addition, the operation of the present invention does not hinge upon the choice of languages and protocols that are used for communication among the intelligent agents. There are several available languages and protocols of intelligent communication known in the art that include, without limitation, KIF, KQML, and others as discussed in Yannis Labrou, Tim Finin, and Yun Peng, Agent Communication Languages: The Current Landscape, IEEE Intelligent Systems, March/April 1999, at 45-52, which is incorporated herein by reference.

### BRIEF DESCRIPTION OF THE DRAWINGS

FIG. 1 is an overall schematic diagram of the present invention;

FIG. 2 is a flow diagram showing how the present invention interprets a human question;

FIG. 3 is a flow diagram of conceptual parsing according to the present invention;

FIG. 4 is a flow diagram of matching according to the present invention;

FIG. 5 is a flow diagram of decomposition according to the present invention; and

FIG. 6 is a flow diagram of user login according to the present invention.

### DETAILED DESCRIPTION OF THE PREFERRED EMBODIMENT

The present invention is a system and method that takes a question in natural language syntax, a question that is phrased in natural language syntax coupled with additional information, or any other input to which a response may be provided (“human question”) and outputs a response that also is in natural language syntax, in natural language syntax coupled with additional data, or any other form of output that can be understood by a human (“human answer”). The input can be in any language and can be in a variety of media including, without limitation, sound, video, optical character recognition (“OCR”), and text. Input in the form of text may include, without limitation, data entered using a keyboard, the content of a file, and reference to the content of a file using the file name or a pointer (e.g., www.gd-es.com). The text input used with the present invention likewise may be in various formats including, without limitation, “pdf” files, Microsoft documents, and structured files. The output likewise can be in any language and can be in a variety of media including, without limitation, voice, video, and text.

As detailed below, the present invention utilizes one or more intelligent agents to output a human answer in response to a human question input by a user. Each intelligent agent functions to perform a specific task, but all of the intelligent agents operate according to the same underlying principle: to decompose the human question into one or more “simplified” questions that can be answered by machine intelligence (“machine actionable questions”). As detailed below, each intelligent agent is dedicated to decompose the human question according to the specific function of the intelligent agent, with a brain agent operating to coordinate the activities of the other intelligent agents.

The human question is decomposed in a manner that removes the “human” interpreting elements of the question to reduce the question to factual inquires that can be solved by machine intelligence. Each intelligent agent may employ an error handling agent to compensate for errors or ambiguities in the human question. In addition, each intelligent agent may employ one or more connectors that enable the intelligent agent to communicate with external data sources. Although each intelligent agent may interface with outside sources using its own connector, it is preferable that one set of connectors interface with the brain agent, and the other intelligent agents access outside sources through the connectors interfaced with the brain agent.

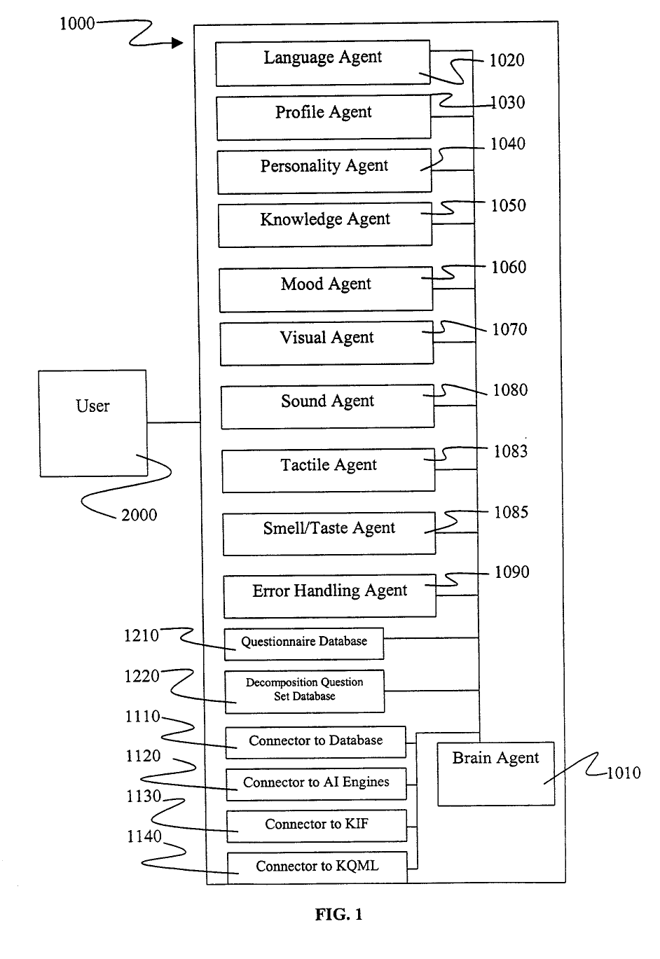

Referring to FIG. 1, the present invention comprises a brain agent 1010, and one or more of the following intelligent agents: a language agent 1020; a profile agent 1030; a personality agent 1040; a knowledge agent 1050; a mood agent 1060; a visual agent 1070; a sound agent 1080; a tactile agent 1083; a smell/taste agent 1085; and an error handling agent 1090. The present invention may further comprise one or more connectors to link the system 1000 with external data sources of information. These connectors may include, without limitation: a database connector 1110; an artificial intelligence (“Al”) engine connector 1120; a Knowledge Interchange Format (“KIF”) protocol connector 1130; and a Knowledge Query and Manipulation Language (“KQML”) protocol connector 1140. The present invention also may comprise a questionnaire database 1210 and a decomposition question set database 1220. As would be known to those skilled in the art, while databases 1210 and 1220 are shown separately, they may both be part of the same component, as appropriate. As provided in detail below, brain agent 1010 receives as input a human question from a user 2000 and coordinates the activities of the various agents to output a human answer to user 2000.

Immediately following is a detailed description of the individual components of the present invention. Then a description concerning the use of present invention is set forth.

1. Brain Agent

Brain agent 1010 is used to coordinate the activities of and communication between the various intelligent agents employed in the present invention. Brain agent 1010 receives input from a user 2000, distributes that input to the appropriate intelligent agents, outputs requests for feedback or further refinement of the user's human question when needed, coordinates communication between and interacts with the various intelligent agents, and outputs a human answer to user 2000. Brain agent 1010 may further be used to connect one or more of the intelligent agents to other databases using a database connector 1110, to connect one or more intelligent agents to other artificial intelligence (“AI”) engines using an AI connector 1120, to connect one or more intelligent agents to other systems that use KIF protocol using KIF connector 1130, and to connect one or more intelligent agents to other systems that use KQML protocol using KQML connector 1140.

Following is a summary of the typical operation of brain agent 1010. Brain agent 1010 receives a human question. Brain agent 1010 then notifies the various intelligent agents. One or more of the various intelligent agents examine the question. If appropriate, one or more of the intelligent agents communicates back to brain agent 1010 to relay information that may assist brain agent 1010 in interpreting the human question.

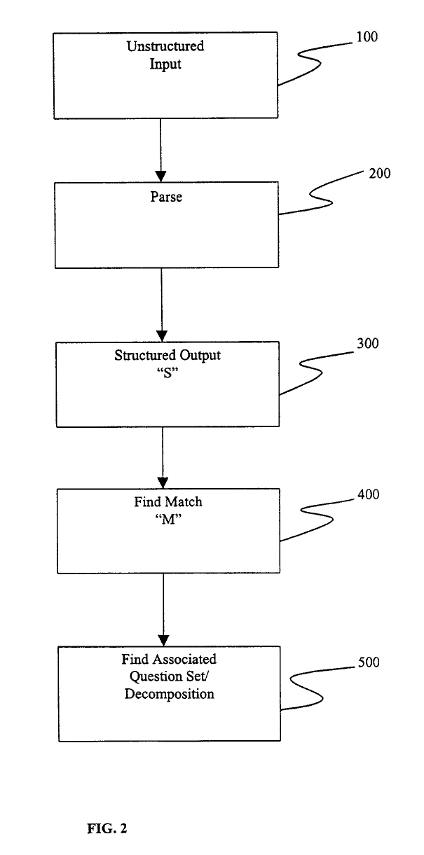

Referring to FIG. 2, a flow diagram is shown of the preferred manner in which brain agent 1010 operates to interpret a human question. As would be known to those skilled in the art, the present invention is not limited to the flow diagram shown in FIG. 2, as any appropriate method for interpreting a human question may be used according to the present invention. In step 100, brain agent 1010 receives a human question input by user 2000. The human question is referred to as “Unstructured Input” in step 100. In step 200, the human question is parsed. In step 300, the parsed information is translated into a structured form, referred to as “S.” In step 400, brain agent 1010 tries to match S with another structured form entry within questionnaire database 1210 (shown in FIG. 1). A match, if any, that is located during step 400 between S and another structured form entry is referred to as a “matched entry” or “M.” In step 500, brain agent 1010 determines the set of refined set of questions that are linked to M. Step 500 is commonly referred to in the art as a “decomposition step.” Steps 200, 400, and 500 are described in further detail below. During each of the steps shown in FIG. 2, brain agent 1010 may interact with one or more of the other intelligent agents, as appropriate.

a. Parsing

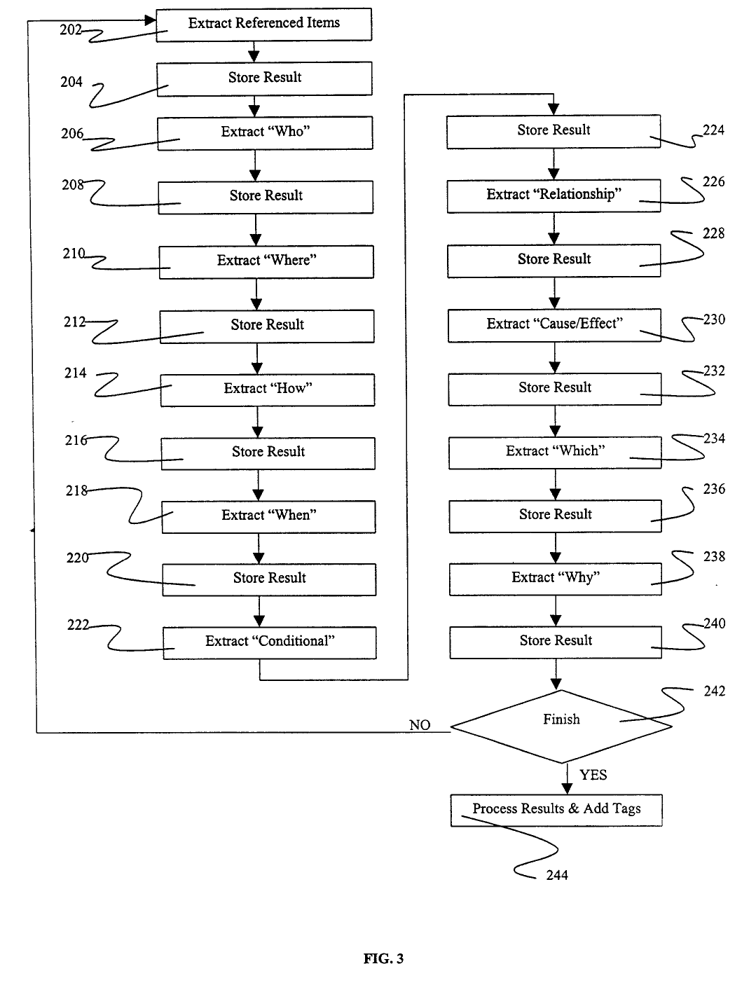

Referring now to FIG. 3, a preferred embodiment of carrying out the parsing performed in step 200 of FIG. 2 is shown. As would be known to those skilled in the art, step 200 is not limited to the flowchart shown in FIG. 3, as any appropriate parsing method may be used according to the present invention. An example of one conventional method of parsing is provided in U.S. Pat. No. 5,309,359 to Katz et al.

FIG. 3 provides an example of “conceptual parsing” that can be carried out according to the present invention. Through conceptual parsing according to the present invention, a human question (or unstructured input) is parsed into fragments based upon the concepts presented in the human question rather than the grammatical structure of the human question. Conventional parsing typically is based upon the grammatical structure of the human question. Conventional parsing may be used according to the present invention, but the preferred embodiment of the present invention uses conceptual parsing, as discussed in detail below. The parsing steps described below may be replicated for each language (e.g., English, German, and Spanish). Alternatively, the human question could be translated into one “standard” language (e.g., English) before proceeding to the parsing steps.

When parsing, as well as conceptually parsing, a human question is decomposed into fragments, and each fragment typically is attached to the right of its respective tags. Tags used in conventional parsing are known to those skilled in the art. Tags used in the conceptual parsing of a human question into structured form include, without limitation, the following: RELATIONSHIP:; CAUSE/EFFECT:; WHEN:; WHERE:; WHY:; HOW:; CONDITIONAL:; WHICH:; WHO:; and REFERENCE:. Note that as discussed below, there can be a plurality of structured-form “sentences” mapped by a single question. Following are some examples of the conceptual parsing process according to the present invention. In the following examples, a question mark (?) indicates the subject of the question:

HUMAN QUESTION

1. Why is the sky blue?

PARSING PROCESS

1(a). CAUSE/EFFECT: ?/blue sky

1(b). WHY:?Blue sky

(Note that 1(a) and 1(b) are two possible parsed results from the same human question 1.)

HUMAN QUESTION

2. Where is the closest airport?

PARSING PROCESS

2. WHERE:?closest airport CONDITIONAL: <current location>

(Note that angle brackets denote pointers.)

HUMAN QUESTION

3. Whose face is in the picture?

PARSING PROCESS

3. WHO:? CONDITIONAL: face in the <video>

(Note that <video> references to the video source.)

Referring to FIG. 3, the preferred embodiment of carrying out step 200 of FIG. 2 will be explained. In step 202, one or more “referenced items” are first extracted from the human question, and the referenced items are then stored for later processing in step 204. In step 206, the “who” part of the human question is extracted, and the “who” part is then stored for later processing step 208. In step 210, the “where” part of the human question is extracted, and the “where” part is then stored for later processing step 212. In step 214, the “how” part of the human question is extracted, and the “how” part is then stored for later processing step 216. In step 218, the “when” part of the human question is extracted, and the “when” part is then stored for later processing step 220. In step 222, the “conditional” part of the human question is extracted, and the “conditional” part is then stored for later processing step 224. In step 226, the “relationship” part of the human question is extracted, and the “relationship” part is then stored for later processing step 228. In step 230, the “cause/effect” part of the human question is extracted, and the “cause/effect” part is then stored for later processing step 232. In step 234, the “which” part of the human question is extracted, and the “which” part is then stored for later processing step 236. In step 238, the “why” part of the human question is extracted, and the “why” part is then stored for later processing step 240. In step 242, the human question is analyzed to determine if further parsing is necessary. If further parsing is necessary, the parsing process continues again at step 202. If further parsing is not necessary, the process continues to step 244, where the parts extracted from the human question are processed and tags are added. During the parsing process, brain agent 1010 may interact with one or more of the other intelligent agents, as appropriate.

Referring to FIG. 2, after the human question has been parsed in step 200, the results typically are output in a structured form (referred to as “S”) in step 300.

b. Matching

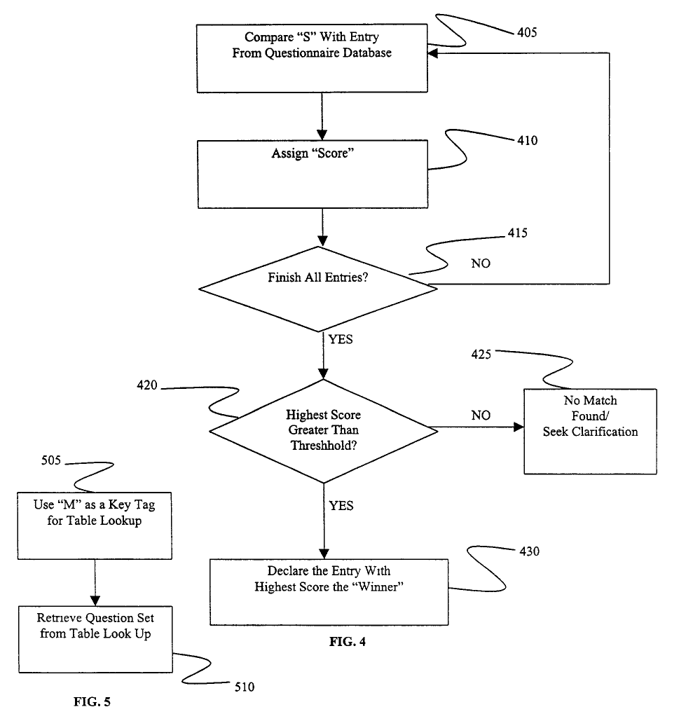

As shown in FIG. 2, during step 400 the present invention typically tries to match S with another structured-form entry from a questionnaire database 1210 (shown in FIG. 1). Referring to FIG. 4, a preferred method for matching S with another structured-form entry is shown. As would be known to one skilled in the art, the matching process of the present invention is not limited to that shown in FIG. 4. Various other methods for matching may be used according to the present invention, including, without limitation, those discussed in Gerard Salton, Automatic Information Retrieval, IEEE Computer, September 1980, at 41-56 and Chung-Shu Yang and Gerard Salton, Best-Match Querying in General Database Systems—A Language Approach, IEEE Computer Society's Second International Computer Software and Applications Conference, at 458-63 (1978), both of which are incorporated herein by reference.

In step 405, S is compared with entries stored in a questionnaire database 1210 (shown in FIG. 1). As the entries are compared with S, a score is assigned to each entry in step 410. In step 415, the present invention determines whether all entries from questionnaire database 1220 have been compared with S. If all entries have been compared, the matching process proceeds to step 420. If all entries have not been compared, the matching process returns to step 405. After all entries have been compared with S, the scores of all entries are compared with a “threshold” score in step 420. If none of the scores for any entry exceed the threshold score, the matching process continues to step 425. In step 425, brain agent 1010 may seek clarification from user 2000 so that entries exceeding the threshold score may be located. If the scores for one or more of the entries exceeds the threshold, the matching process continues to step 430. In step 430, the entry with the highest score is declared the “winner,” and the “winning” entry is referred to as “M.”

c. Decomposition

Referring to FIG. 2, the process for interpreting the human question continues to step 500, where a question set associated with M is located. Step 500 is commonly referred to in the art as decomposition. Typically, the intent of the decomposition step is both to decrease the complexity of the question and to interject knowledge by constructing a set of relevant and useful questions. As would be known by those skilled in the art, there are several ways to implement this decomposition step. Accordingly, the decomposition process of the present invention is not limited to the process shown in FIG. 5, as any appropriate decomposition method also may be used.

Referring to FIG. 5, a preferred embodiment of the decomposition process (as discussed further below) is shown. The preferred embodiment of the decomposition process uses a table-look-up approach. For example, the table could be in the form of a decomposition question set database 1220 (shown in FIG. 1). In step 505, the input key to the table is M (the parsed structured elements of the human question posed by user 2000). In Step 510, the table output contains the parsed structured elements of a set of simpler questions or pointers to them. Brain agent 1010 then notifies the intelligent agents to retrieve the answers to the table output. For example, the question “What is the latest US population?” (M) would produce the following set of questions output from the table-lookup:

“What is the Asian population in U.S. from the 2000 <latest > census?”

“What is the Hispanic population in U.S. from the 2000 <latest> census?”

“What is the African-American population in U.S. from the 2000 <latest> census?”

“What is the Indian population in U.S. from the 2000 <latest> census?”

“What is the Caucasian population in U.S. from the 2000 <latest> census?”

In this example, brain agent 1010 would then interact with knowledge agent 1050 to obtain the answers to the questions output from the lookup table. Typically, the human answer that is output to user 2000 would be the answers to the above questions that are output from the lookup table.

The above questions are written in the natural language format for ease of reading. In actuality, and as would be evident to one skilled in the art, the questions are stored in the structured formats for easy searching and retrieval.

The implementation of decomposition question set database 1220 typically will require manual entries by human experts of different fields. The process could be semi-automated with the expert typing in questions in natural language format and with an engine converting them automatically into entries of structured format. Decomposition question set database 1220 also could be built piecewise by incrementally increasing subject coverage. Conceivably, the process could be completely automated by advanced software implementation in the future.

In the final steps of the process, brain agent 1010 pieces together all of the information received from the various intelligent agents to form the human answer and to get feedback from user 2000.

In an alternate embodiment, the present invention could be dedicated only to the parsing of the human question, with the answer portion of the system delegated entirely to other external systems. In this embodiment, the components would still be as shown in FIG. 1, but they would be utilized only for parsing the human question. External components would be used to compose the human response to the human question. In another embodiment of the present invention that could utilize a hybrid approach, the system would interact with external systems to jointly construct a human answer to the human question. This embodiment also would appear as shown in FIG. 1. In yet another embodiment, the present invention would compose the human answer to the human questions internally, using external systems only during the parsing process. This embodiment also would appear as shown in FIG. 1.

2. Language Agent

Language agent 1020 functions to handle the language aspects of the human question posed by user 2000. Language agent 1020 can be used to determine the language employed by user 2000 to input the human question (e.g., English, French, Chinese, or Arabic), translate the language employed by user 2000 to input the human question into another language, parse the grammar of the human question, to interpret technical terms employed in the human question, and to interpret idioms and proverbs employed in the human question. Language agent 1020 also may be used to perform other linguistic functions including, without limitation, differentiating key words from non-important words (such as articles within the question) and understanding the importance of word orderings and pronoun references.

3. Profile Agent

Profile agent 1030 functions to handle the profile of the use of system 1000 by user 2000. Profile agent 1030 can store a history of the use by user 2000 of the present invention. For example, profile agent 1030 can maintain a “click by click” history of all activities engaged in by user 2000 while using the present invention. Profile agent 1030 may likewise perform a “clickstream analysis” of the activities engaged in by user 2000 to determine the preferences of user 2000 and the underlying intentions of user 2000 for using the present invention.

Profile agent 1030 may interact with error handling agent 1090 to determine proper error compensation before user 2000 is prompted for clarification. Profile agent 1030 also may be used to gather user profile information including, without limitation, subject categories of interest to user 2000 based on past questions posed by user 2000 and the preferable form of presentation to user 2000 based upon whether user 2000 is more visual or auditory at perception.

4. Personality Agent

Personality agent 1040 handles the long term characteristics and historical data concerning user 2000. Such long-term characteristics handled by personality agent 1040 include, without limitation, personality type (e.g., A or B), prejudice, bias, risk aversion (or lack thereof), political inclination, and religious beliefs. Further examples of long term characteristics handled by personality agent 1040 include biometric data concerning the user including, but not limited to, height, weight, hair color, eye color, retinal pattern, fingerprints, and DNA. Examples of historical data of user 2000 handled by personality agent 1040 include, without limitation, educational background, occupational background, locations where user 2000 has dwelled, and aesthetic preferences.

Personality agent 1040 may gather long term character traits and historical data concerning user 2000 during the registration process (discussed below) for use in identifying user 2000 during the login process (discussed below). Personality agent 1040 also may gather long-term character traits and historical data concerning user 2000 during use by user 2000 of the present invention. Personality agent 1040 also may be used to notify brain agent 1010 when drastic changes in the personality profile of user 2000 are detected.

5. Knowledge Agent

Knowledge agent 1050 handles factual information that is not specific to user 2000. Such factual information handled by knowledge agent 1050 includes, without limitation, facts concerning mathematics, science, history, geography, literature, current events, and word relationships such as synonyms, antonyms, and homonyms. For example, knowledge agent 1050 would know that “July 4” is a U.S. Holiday and that the Boston Tea Party has a significant historical context.

6. Mood Agent

Mood agent 1060 handles information concerning the temporary emotional state of user 2000 while user 2000 is interacting with the present invention. Mood agent 1060 interacts with the other intelligent agents to gather information related to the temporary emotional state of user 2000. Mood agent 1060 can analyze input from user 2000 for sarcasm, tone, and diction to determine the temporary emotional state of user 2000. Mood agent 1060 also can analyze the facial expression of user 2000 to determine the temporary emotional state of user 2000. Mood agent 1060 may be used to provide information related to the temporary emotional state of user 2000 to the other intelligent agents for use in interpreting the human questions and providing human answers to user 2000. For example, when mood agent 1060 detects that user 2000 is inattentive or nervous, mood agent 1060 would signal brain agent 1010 or one or more of the other intelligent agents to relay information to user 2000 slowly and redundantly to avoid possible misinterpretation that potentially could result from the state of mind of user 2000.

7. Visual Agent

Visual agent 1070 handles visual information that is input by user 2000. Visual agent may perform functions including, but not limited to: object recognition; scene analysis; face identification; color recognition; shape recognition; texture recognition; lighting recognition; age detection; and gender identification. For example, the question “Where is the closest airport?” by user 2000 may trigger visual agent 1070 to perform scene analysis of the background of the video image (if available) of user 2000. Such analysis may yield landmark information and other clues regarding where user 2000 is located, thus helping to answer the human question posed by user 2000.

8. Sound Agent

Sound agent 1080 handles audio information that is input by user 2000. Sound agent 1080 may perform functions including, but not limited to: voice-to-text translation; accent detection; gender identification; age detection; speech rate detection; voice identification; sound recognition; and volume detection. For example, brain agent 1010 will launch sound agent 1080 when user 2000 will provide voice input. Sound agent 1080 may be used to translate the voice input from user 2000 into text, and then provide the text to the other intelligent agents as appropriate. As another example, sound agent 1080 may be used to detect whether user 2000 speaks with an accent, and then may determine the geographic region that the detected accent in indigenous to, if possible. In detecting the accent of user 2000, sound agent 1080 may collaborate with one or more of the other intelligent agents. For example, sound agent 1080 may collaborate with knowledge agent 1050 to determine the region that the accent of user 2000 is indigenous to. Sound agent 1080 also may collaborate with personality agent 1040 to determine whether long term character traits of user 2000 match character traits typically associated with the detected accent. In addition, sound agent 1080 may also be used to recognize inanimate sounds including, without limitation, thunder, an explosion, music, and animal sounds.

9. Tactile Agent

Tactile agent 1083 handles tactile information that is input by user 2000. Tactile agent 1083 may perform functions including, but not limited to, the following: pressure sensing, temperature sensing, moisture sensing, and texture sensing. For example, user 2000 can input text, data, and drawings by writing on a pressure-sensitive pad or motion-position detection apparatus, and tactile agent 1083 may be used to decipher this input. Tactile agent 1083 likewise could be used to register the signature of user 2000 along with any pressure and temporal information associated with the signature. The following questions provide examples of how tactile agent 1083 may be used according to the present invention: “What is the room temperature?” “Where is the crack on this object?” “Is the humidity in this room greater than 72%?” Questions such as the foregoing may trigger tactile agent 1083 to perform the appropriate tactile processing in whole or in part with other intelligent agents as appropriate.

10. Smell/Taste Agent

Smell/taste agent 1085 may be used to process olfactory or other chemical information that is input by user 2000. Smell/taste agent 1085 may perform functions including, but not limited to, scent detection, smell identification, and chemical analysis. For example, user 2000 may input olfactory information by breathing into a tube for breath analysis. This olfactory information could be utilized by the present invention for the purposes of registering the olfactory signature of user 2000 and/or detecting the amount of alcohol or other drugs in the body of user 2000. Other examples of uses of smell/taste agent 1085 according to the present invention are illustrated with the following questions: “Is there poisonous gas in the room?” “Do I have bad breath?” “Is there any illegal substance in the luggage?” “What perfume is she wearing?” These questions may trigger smell/taste agent 1085 to perform the appropriate olfactory or other chemical processing in whole or in part with other intelligent agents as appropriate.

11. Error Handling Agent

Error handling agent 1090 functions to compensate for errors that are present in the input received from user 2000. Such errors may include, without limitation, typos, noisy images or video data, occluded images or video data, and grammatical errors. While error handling agent 1090 is shown as a separate component in FIG. 1, an error handling agent preferably is incorporated into each of the other intelligent agents.

For example, language agent 1020 may incorporate an error handling agent (not shown) to compensate for language errors. The language errors that the error handling agent (not shown) may be utilized to compensate for include, without limitation, spelling and grammatical errors, typos, and unclear language such as the use of double negatives, pronouns with an indefinite antecedent basis, or slang.

Error handling agent 1090 typically will automatically compensate for mistakes without further clarification from user 2000 when a high confidence level exists that the compensation should be made. Error handling agent 1090 may interact with the other intelligent agents, such as profile agent 1030 and personality agent 1040, to determine the confidence level for error compensation. Error handling agent 1090 may prompt user 2000 via brain agent 1010 for clarification when confidence in the error compensation is low or compensation for the error cannot be determined.

The other intelligent agents likewise may include individual error handling agents to compensate for errors in the data received from user 2000. As with the example of the error handling agent incorporated into language agent 1020, the error handling agents incorporated into the other intelligent agents will communicate with the other intelligent agents to determine whether a correction to an error should automatically be made. When the confidence level is low concerning an automatic correction, user 2000 typically will be prompted for addition information to determine how the error should be corrected.

12. Connectors

The present invention may also include one or more connectors to enable system 1000 to communicate with external data sources (including, without limitation, other parallel implementations of the present invention) for assistance in providing output to user 2000. These connectors may permit each intelligent agent to supplement the information contained within each intelligent agent and to seek assistance from external data sources when the information contained within system 1000 is insufficient to address a human question posed by user 2000. These connectors likewise may be used in the alternate embodiments of the present invention described above. While each individual agent may include its own connector or connectors to communicate with outside sources, it is preferable to provide one or more connectors interfaced with brain agent 1010 as shown in FIG. 1, thereby providing a centralized interface for each intelligent agent to communicate with external data sources.

Connectors that may be used according to the present invention include, without limitation, database connector 1110, AI engine connector 1120, KIF connector 1130, and KQML connector 1140. Each of the foregoing connectors may allow any of the intelligent agents to communicate with an external data source. As would be known to those skilled in the art, various other connectors to external data sources also may be employed according to the present invention. Database connector 1110 enables any of the intelligent agents to communicate with external databases. Al connector 1120 enables any of the intelligent agents to communicate with external Al engines including, without limitation, the Cyc system discussed above. KIF connector 1130 enables any of the intelligent agents to communicate with external data sources that use the KIF protocol. KQML connector 1140 enables any of the intelligent agents to communicate with external data sources that use the KQML protocol. Yannis Labrou, Tim Finin, and Yung Peng, Agent Communication Languages: The Current Landscape, IEEE Intelligent Systems, March/April 1999, at 45-52, provides information related to the various communication languages that may be employed by the intelligent agents of the present invention when communicating with external data sources as well as with one another.

13. Login Process

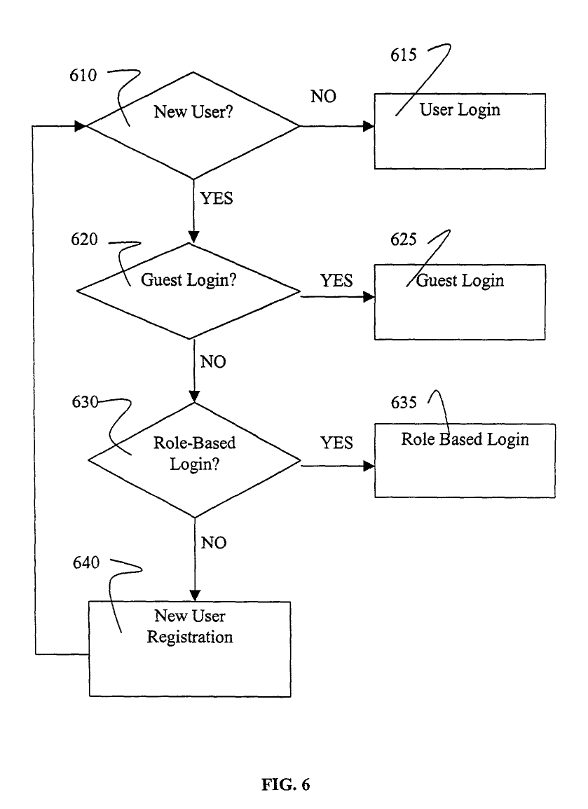

Referring now to FIG. 6, a flow diagram is shown for various login modes that may be used according to the present invention. As would be known to one skilled in the art, various other login modes may be used, and the present invention is not limited to those shown in FIG. 6. In addition, the login process shown in FIG. 6 is not limited to either the steps or order indicated. In step 610, the present invention determines whether user 2000 already has a user-specific account to use the present invention. If user 2000 already has a user-specific account, in step 615 user 2000 will login to use the present invention. This login process is described below.

If user 2000 does not have a user-specific account to use the present invention (i.e., is a new user), in step 620 user 2000 will be given the option of using a guest login account. If user 2000 elects to use a guest login account, in step 625 user 2000 is provided access to the present invention with a guest login account. When using a guest login account, user 2000 would not benefit from any personalization that could be used in interpreting the human question and constructing the human answer.

If user 2000 elects not to use a guest login account, in step 630 user 2000 will be given the option of using a role-based login account. If user 2000 elects to use a role-based login account, in step 635 user 2000 will be provided access to the present invention with a role-based login account. When using a role-based account, user 2000 may select a role from a list of representative role personalities; this would provide a stereotypical and partial personalization of user 2000 for use in interpreting the human question and constructing the human answer.

If user 2000 elects not to use a role-based account, in step 640 user 2000 will be given the option of obtaining a user-specific account by registering to use the present invention. The registration process of step 640 is described in detail below. After user 2000 has registered to obtain a user-specific account, or if user 2000 elects not to register, the login process returns to step 610.

The registration process of step 640 typically utilizes a variety of media and preferably serves to collect information regarding user 2000 that will enable the present invention to confirm the identity of user 2000 during later use and to prevent others from masquerading as user 2000 while using the present invention. The registration process of step 640 also typically may be used to collect information for use by personality agent 1040. Through brain agent 1010, the intelligent agents will prompt a new user 2000 with a variety of questions and other information requests to register user 2000 with system 1000. Questions posed to user 2000 during the registration process may include, without limitation, the user's name, address, birth date, and educational background. The system may also ask personality test questions including, without limitation, questions concerning the user's political beliefs, religious beliefs, and other subject matters that may be used to discern personality traits of the user.

During the registration process, the present invention also may ask the new user 2000 to provide information for use in confirming the identity of the new user during subsequent interaction with system 1000. The user may be prompted to provide biometric information including, without limitation, a voice sample, a fingerprint sample, a snapshot of the user's face, an image of the blood vessels of the user's retina, a scan of brain waves, or a DNA sample. In addition to being used for identification purposes, this information may be utilized by the intelligent agents to supplement the user's personality profile and for other purposes.

Once the new user has provided information sufficient to confirm the identity of the user during subsequent interaction with system 1000, the new user will be issued a user-specific login account and password for subsequent use.

14. User Interaction

Once a new user 2000 has been issued a user-specific login account and password, this user 2000 may interact with system 1000. User 2000 will input his or her user-specific login account and password. System 1000 also may ask user 2000 to provide additional information such as a fingerprint, retinal scan, real time facial snapshot, voice sample, or other information that may be used to confirm the identity of user 2000. Once the identity of user 2000 has been confirmed, system 1000 will prompt the user to select an input mode such as text, voice or other audio, or visual input. System 1000 will then prompt user 2000 to input a human question. User 2000 may also interact with the present invention using either a guest login or role-based login, as discussed above. However, when using a guest login account, user 2000 would not benefit from any personalization. In addition, when using a role-based login, user 2000 would benefit only from stereotypical and partial personalization.

Brain agent 1010 will receive the human question input by user 2000. Once the human question is received, brain agent 1010 will launch the appropriate intelligent agents to be used in interpreting the human question (as discussed above) and, later, in constructing a human answer. The appropriate intelligent agents will receive the human question and refine the question into one or more simpler questions that can be interpreted using machine intelligence. The intelligent agents may interact with one another as the human question is interpreted. In one aspect of the invention, personality agent 1040, profile agent 1030, and mood agent 1060 typically may play important roles in assisting the other intelligent agents to interpret the human question because these agents may be used to put the human question into context from the perspective of user 2000. As discussed above, brain agent 1010 functions to coordinate the interaction between the various intelligent agents.

While the human question is interpreted by one or more of the intelligent agents, one or more of the intelligent agents may prompt user 2000 for additional information to clarify the human question or to correct an error that could not be automatically corrected by error handling agent 1090. In addition, one or more of the intelligent agents may utilize one or more of the connectors including database connector 1110, AI engine connector 1120, KIF connector 1130, or KQML connector 1140 to obtain information or assistance that is available external to system 1000.

Through the interaction of the various intelligent agents, a human answer is constructed in response to the human question input by user 2000. Brain agent 1010 transmits the human answer to user 2000 in the media format requested by user 2000. After user 2000 has received the human answer, system 1000 may prompt the user to evaluate the human answer for clarity, relevance, and other factors that may be used to assess the performance of the present invention.

System 1000 may then prompt user 2000 to input another human question or to log-off from the system. Either during the interaction with user 2000 or after user 2000 has logged-off, system 1000 may update the information stored in profile agent 1030, personality agent 1040, and any of the other intelligent agents that may benefit from the data exchanged during the interaction with user 2000.

Thus, there has been described an apparatus and method for problem solving using intelligent agents. In one aspect of the present invention, intelligent agents that are dedicated to specific functions interact with a brain agent to provide human answers in response to human questions. In another aspect of the present invention, the human question is parsed in a conceptual manner. In yet another aspect of the present invention, the personality and other characteristics specific to the individual user interacting with the present invention are utilized when composing the human answer.

Whereas the present invention has been described with respect to specific embodiments thereof, it will be understood that various changes and modifications will be suggested to one skilled in the art and it is intended that the invention encompass such changes and modifications as fall within the scope of the appended claims.

What is claimed is:

1. A system for problem solving, comprising:
a language agent;
a knowledge agent; and
a brain agent; wherein
said brain agent is adapted to receive input and to selectively interact with said language agent and said knowledge agent to interpret the input and to provide output in response to the input.

2. The system as recited in claim 1, wherein
said brain agent is further adapted to selectively interact with said language agent and said knowledge agent to conceptually parse the input.

3. The system as recited in claim 1, further comprising:
one or more external data sources;
one or more connectors to said one or more external data sources; and wherein
said brain agent is further adapted to selectively interact with said one or more connectors.

4. The system as recited in claim 1, further comprising:
one or more external data sources;
one or more connectors to said one or more external data sources; and wherein
one or more of said language agent and said knowledge agent is adapted to selectively interact with said one or more connectors.

5. The system as recited in claim 1, further comprising:
a personality agent, and wherein
said brain agent is further adapted to selectively interact with said personality agent to interpret the input and provide output in response to the input.

6. The system as recited in claim 5, wherein
said brain agent is further adapted to selectively interact with said language agent, said knowledge agent, and said personality agent to conceptually parse the input.

7. The system as recited in claim 5, further comprising:
one or more external data sources;
one or more connectors to said one or more external data sources; and wherein
said personality agent is adapted to selectively interact with said one or more connectors.

8. The system as recited in claim 1, further comprising:
an error handling agent, and wherein
said brain agent is further adapted to selectively interact with said error handling agent to interpret the input and to provide output in response to the input.

9. The system as recited in claim 8, wherein
said brain agent is further adapted to selectively interact with said language agent, said knowledge agent, and said error handling agent to conceptually parse the input.

10. The system as recited in claim 8, further comprising:
one or more external data sources;
one or more connectors to said one or more external data sources; and wherein
said error handling agent is adapted to selectively interact with said one or more connectors.

11. The system as recited in claim 1, further comprising:
a profile agent, and wherein
said brain agent is further adapted to selectively interact with said profile agent to interpret the input and to provide output in response to the input.

12. The system as recited in claim 11, wherein
said brain agent is further adapted to selectively interact with said language agent, said knowledge agent, and said profile agent to conceptually parse the input.

13. The system as recited in claim 11, further comprising:
one or more external data sources;
one or more connectors to said one or more external data sources; and wherein
said profile agent is adapted to selectively interact with said one or more connectors.

14. The system as recited in claim 1, further comprising:
a mood agent, and wherein
said brain agent is further adapted to selectively interact with said mood agent to interpret the input and to provide output in response to the input.

15. The system as recited in claim 14, wherein
said brain agent is further adapted to selectively interact with said language agent, said knowledge agent, and said mood agent to conceptually parse the input.

16. The system as recited in claim 14, further comprising:
one or more external data sources;
one or more connectors to said one or more external data sources; and wherein
said mood agent is adapted to selectively interact with said one or more connectors.

17. The system as recited in claim 1, further comprising:
a visual agent, and wherein
said brain agent is further adapted to selectively interact with said visual agent to interpret the input and to provide output in response to the input.

18. The system as recited in claim 17, wherein
said brain agent is further adapted to selectively interact with said language agent, said knowledge agent, and said visual agent to conceptually parse the input.

19. The system as recited in claim 17, further comprising:
one or more external data sources;
one or more connectors to said one or more external data sources; and wherein
said visual agent is adapted to selectively interact with said one or more connectors.

20. The system as recited in claim 1, further comprising:
a sound agent, and wherein
said brain agent is further adapted to selectively interact with said sound agent to interpret the input and to provide output in response to the input.

21. The system as recited in claim 20, wherein
said brain agent is further adapted to selectively interact with said language agent, said knowledge agent, and said sound agent to conceptually parse the input.

22. The system as recited in claim 20, further comprising:
one or more external data sources;
one or more connectors to said one or more external data sources; and wherein
said sound agent is adapted to selectively interact with said one or more connectors.

23. The system as recited in claim 1, further comprising:
a tactile agent, and wherein
said brain agent is further adapted to selectively interact with said tactile agent to interpret the input and to provide output in response to the input.

24. The system as recited in claim 23, wherein
said brain agent is further adapted to selectively interact with said language agent, said knowledge agent, and said tactile agent to conceptually parse the input.

25. The system as recited in claim 23, further comprising:
one or more external data sources;
one or more connectors to said one or more external data sources; and wherein
said tactile agent is adapted to selectively interact with said one or more connectors.

26. The system as recited in claim 1, further comprising:
a smell/taste agent, and wherein
said brain agent is further adapted to selectively interact with said smell/taste agent to interpret the input and to provide output in response to the input.

27. The system as recited in claim 26, wherein
said brain agent is further adapted to selectively interact with said language agent, said knowledge agent, and said smell/taste agent to conceptually parse the input.

28. The system as recited in claim 26, further comprising:
one or more external data sources;
one or more connectors to said one or more external data sources; and wherein
said smell/taste agent is adapted to selectively interact with said one or more connectors.

29. A method for problem solving, comprising the steps of:
receiving input; and
using a brain agent to selectively interact with a language agent and a knowledge agent to interpret the input and to provide output in response to the input.

30. The method as recited in claim 29, further comprising the step of:
using the brain agent to selectively interact with the language agent and the knowledge agent to conceptually parse the input.

31. The method as recited in claim 29, further comprising the step of:
using the brain agent to selectively interact with one or more connectors to one or more external data sources.

32. The method as recited in claim 29, further comprising the step of:
using one or more of the language agent and the knowledge agent to selectively interact with one or more connectors to one or more external data sources.

33. The method as recited in claim 29, further comprising the step of:
using the brain agent to selectively interact with a personality agent to interpret the input and to provide output in response to the input.

34. The method as recited in claim 33, further comprising the step of: using the brain agent to selectively interact with the language agent, the knowledge agent, and the personality agent to conceptually parse the input.

35. The method as recited in claim 33, further comprising the step of:
using one or more of the language agent, the knowledge agent, and the personality agent to selectively interact with one or more connectors to one or more external data sources.

36. The method as recited in claim 29, further comprising the step of:
using the brain agent to selectively interact with an error handling agent to interpret the input and to provide output in response to the input.

37. The method as recited in claim 36, further comprising the step of:
using the brain agent to selectively interact with the language agent, the knowledge agent, and the error handling agent to conceptually parse the input.

38. The method as recited in claim 36, further comprising the step of:
using one or more of the language agent, the knowledge agent, and the error handling agent to selectively interact with one or more connectors to one or more external data sources.

39. The method as recited in claim 29, further comprising the step of:
using the brain agent to selectively interact with a profile agent to interpret the input and to provide output in response to the input.

40. The method as recited in claim 39, further comprising the step of using the brain agent to selectively interact with the language agent, the knowledge agent, and the profile agent to conceptually parse the input.

41. The method as recited in claim 39, further comprising the step of using one or more of the language agent, the knowledge agent, and the profile agent to selectively interact with one or more connectors to one or more external data sources.

42. The method as recited in claim 29, further comprising the step of:
using the brain agent to selectively interact with a mood agent to interpret the input and to provide output in response to the input.

43. The method as recited in claim 42, further comprising the step of:
using the brain agent to selectively interact with the language agent, the knowledge agent, and the mood agent to conceptually parse the input.

44. The method as recited in claim 42, further comprising the step of:
using one or more of the language agent, the knowledge agent, and the mood agent to selectively interact with one or more connectors to one or more external data sources.

45. The method as recited in claim 29, further comprising the step of:
using the brain agent to selectively interact with a visual agent to interpret the input and to provide output in response to the input.

46. The method as recited in claim 45, further comprising the step of: using the brain agent to selectively interact with the language agent, the knowledge agent, and the visual agent to conceptually parse the input.

47. The method as recited in claim 45, further comprising the step of:
using one or more of the language agent, the knowledge agent, and the visual agent to selectively interact with one or more connectors to one or more external data sources.

48. The method as recited in claim 29, further comprising the step of:
using the brain agent to selectively interact with a sound agent to interpret the input and to provide output in response to the input.

49. The method as recited in claim 48, further comprising the step of:
using the brain agent to selectively interact with the language agent, the knowledge agent, and the sound agent to conceptually parse the input.

50. The method as recited in claim 48, further comprising the step of:
using one or more of the language agent, the knowledge agent, and the sound agent to selectively interact with one or more connectors to one or more external data sources.

51. The method as recited in claim 29, further comprising the step of:
using the brain agent to selectively interact with a tactile agent to interpret the input and to provide output in response to the input.

52. The method as recited in claim 51, further comprising the step of: using the brain agent to selectively interact with the language agent, the knowledge agent, and the tactile agent to conceptually parse the input.

53. The method as recited in claim 51, further comprising the step of:
using one or more of the language agent, the knowledge agent, and the tactile agent to selectively interact with one or more connectors to one or more external data sources.

54. The method as recited in claim 29, further comprising the step of:
using the brain agent to selectively interact with a smell/taste agent to interpret the input and to provide output in response to the input.

55. The method as recited in claim 54, further comprising the step of:
using the brain agent to selectively interact with the language agent, the knowledge agent, and the smell/taste agent to conceptually parse the input.

56. The method as recited in claim 54, further comprising the step of:
using one or more of the language agent, the knowledge agent, and the smell/taste agent to selectively interact with one or more connectors to one or more external data sources.
